(19) United States
(12) Patent Application Publication
(10) Pub. No.: US 2011/0194201 A1
(43) Pub. Date: Aug. 11, 2011

(54) DOOR MIRROR FOR AUTOMOBILE

(75) Inventor: Ryo MURAMATSU, Fujieda-shi (JP)

(73) Assignee: MURAKAMI CORPORATION, Shizuoka (JP)

(21) Appl. No.: 12/957,753

(22) Filed: Dec. 1, 2010

(30) Foreign Application Priority Data
Feb. 8, 2010 (JP) 2010-025357

(51) Int. Cl. B60R 1/06

(52) U.S. Cl. 359/871

(57) ABSTRACT

If a lip portion of a gasket is brought into contact with a peripheral wall face on the upper side of a door mirror mounting portion strongly from an arrow A direction, an elastic portion is largely deformed so as to deflect outward when the lip portion is retreated, and the lip portion controls a force that hits the peripheral wall face of the door mirror mounting portion. Therefore, whether a distal end portion of the lip portion hits the peripheral wall face of the door mirror mounting portion disposed on a front door weakly or strongly due to variation in accuracy of a component, the distal end portion of the lip portion and the peripheral wall face of the door mirror mounting portion can be reliably brought into close contact with each other. And a gap is hardly generated between the peripheral wall face on the upper side of the door mirror mounting portion and the lip portion, generation of a wind noise can be prevented, water tightness can be improved, and contribution is made to improvement of an appearance quality of a joint when a door mirror is attached to the front door.

### CROSS-REFERENCE TO RELATED APPLICATION

This application claims the benefit of the following application filed in the Japanese Patent Office: Japanese Patent Application 2010-025357 filed Feb. 8, 2010, the disclosures of all of which are herein incorporated by reference in their entireties.

### BACKGROUND OF THE INVENTION

1. Field of the Invention

The present invention relates to a door mirror for an automobile provided with a gasket arranged between a door mirror base and a car body panel.

2. Related Background Art

A prior-art technology in this field includes Japanese Unexamined Patent Application Publication No. 2003-312361. In a gasket used in a door mirror described in this gazette has a lip portion formed so as to stand from a gasket main body portion, and a distal end portion of this lip portion is exposed between a door mirror base and a car body panel. By exposing the lip portion to the outside as above, an upper edge portion of the door mirror base is edged by a given width of the lip portion, and appearance of the door mirror can be improved.

### SUMMARY OF THE INVENTION

### Technical Problem

However, with the above-described prior art door mirror, since the distal end of the lip portion exposed to the outside such as the edge of the door mirror base has a thickness, if a thickness dimension of the distal end portion of the lip portion is varied, a gap can be easily generated between the car body panel and the lip portion. And thus, this slight gap easily causes a wind noise and moreover, there is a problem that water can easily intrude between the gasket and the car body panel. Also, such a gap might deteriorate an appearance quality of a joint between the door mirror and the car body panel.

The present invention has an object to provide a door mirror for an automobile that can improve the appearance quality of the joint when the door mirror is attached to the car body panel by making generation of a gap difficult between the car body panel or a molding fixed to the car body panel and the lip portion.

### Means for Solving the Problem

The present invention is characterized in that a door mirror for an automobile comprising: a door mirror base fixed to a car body panel; a gasket attached to the door mirror base; and a door mirror main body mounted to the door mirror base, wherein the gasket includes: a gasket main body portion brought into contact with the door mirror base; a lip portion extending along a peripheral edge of the door mirror base and exposed with a predetermined width from the peripheral edge of the door mirror base; and an elastic portion formed between the gasket main body portion and the lip portion, and having one end connected to the lip portion through a first bent portion and the other end connected to the gasket main body portion through a second bent portion, and wherein between the first bent portion and the second bent portion, a gap is formed between the elastic portion and the door mirror base; and the lip portion has a distal end portion brought into contact with the car body panel or a molding fixed to the car body panel so as to be compressed in a width direction of the lip portion.

This gasket used in the door mirror for an automobile has the lip portion exposed with a predetermined width from the peripheral edge of the door mirror base. This lip portion has the distal end portion brought into contact with the car body panel or the molding fixed to the car body panel so as to be compressed in the width direction of the lip portion. Since the gap is formed between the elastic portion and the door mirror base, the lip portion is compressed by the contact and retreated to a direction to reduce the gap. Moreover, since the elastic portion is connected to the door mirror base and the lip portion through the bent portions, the elastic portion can be deformed so as to be deflected when the lip portion is retreated. As a result, whether the distal end portion of the lip portion is brought into contact with the car body panel or the molding fixed to the car body panel weakly or strongly due to variation in accuracy of the gasket itself or an automobile component (such as a door, a molding fixed to a window frame and the like), the distal end portion of the lip portion and the car body panel or the molding fixed to the car body panel can be reliably brought into close contact with each other. Then, a gap is hardly generated between the car body panel or the molding fixed to the car body panel and the lip portion, generation of a wind noise is prevented, water tightness is improved, and contribution can be made to improvement of the appearance quality of the joint when the door mirror is attached to the car body panel.

Also, on the inner face side in the second bent portion, a recess portion extending along the extending direction of the distal end portion of the lip portion is preferably formed. The smaller the thickness of the elastic portion is made, the more easily the elastic portion deflects, but if the elastic portion is made thinner, when the distal end portion of the lip portion is brought into contact with the car body panel or the molding fixed to the car body panel, the elastic portion loses elasticity and a gap can be easily generated between the distal end portion of the lip portion and the car body panel or the molding fixed to the car body panel. Thus, by forming the recess portion extending along the extending direction of the distal end portion of the lip portion in the inner-side bent portion connecting the other end of the elastic portion and the gasket main body portion, whether the distal end portion of the lip portion is brought into contact with the car body panel or the molding fixed to the car body panel weakly or strongly due to variation in accuracy of the component, deflection of the elastic portion can be easily controlled while the elasticity of the elastic portion is maintained.

Also, the recess portion preferably has a C-shaped section. By employing such configuration, the elastic portion can be reliably deflected so as to bend outward.

### Advantageous Effects of Invention

According to the present invention, generation of a gap between the car body panel or the molding fixed to the car body panel and the lip portion is made difficult so that the appearance quality of the joint when the lip portion is attached to the car body panel can be improved.

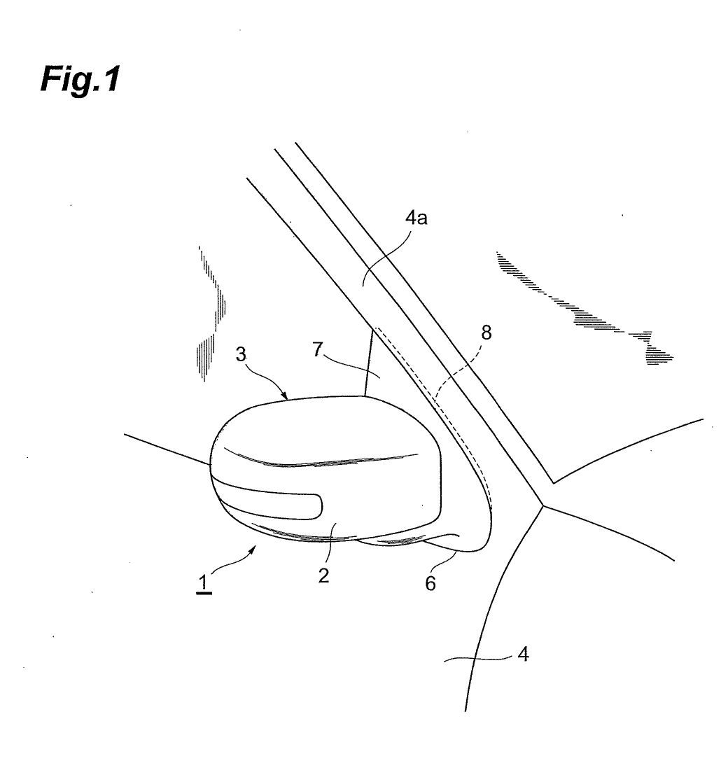

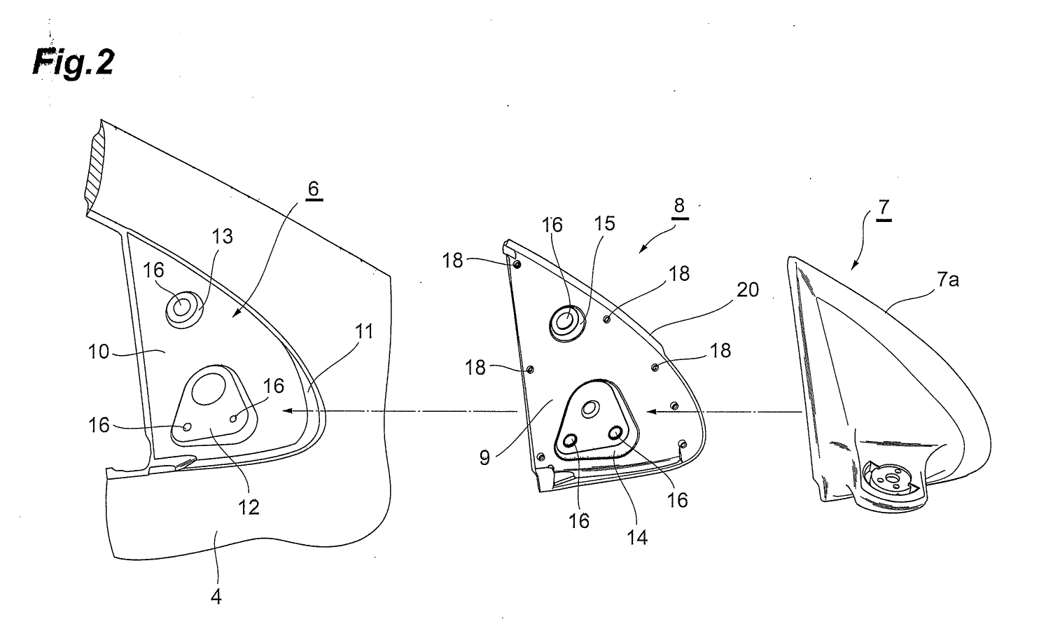

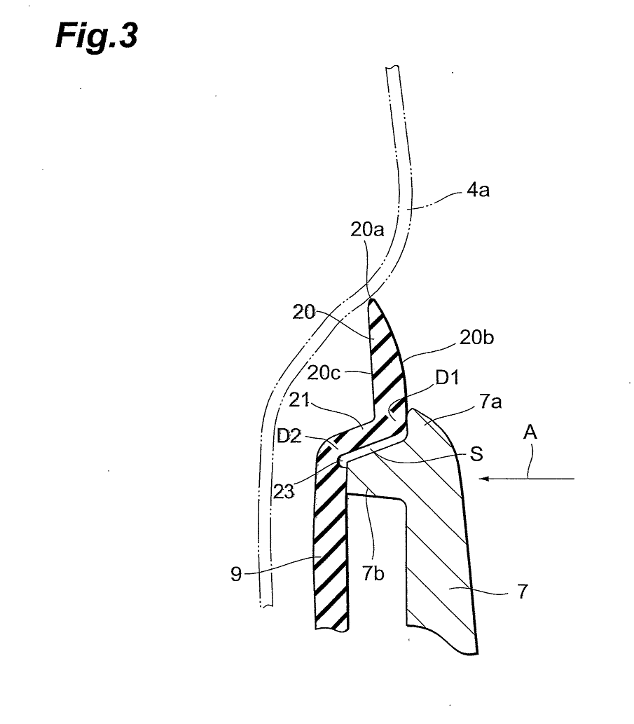

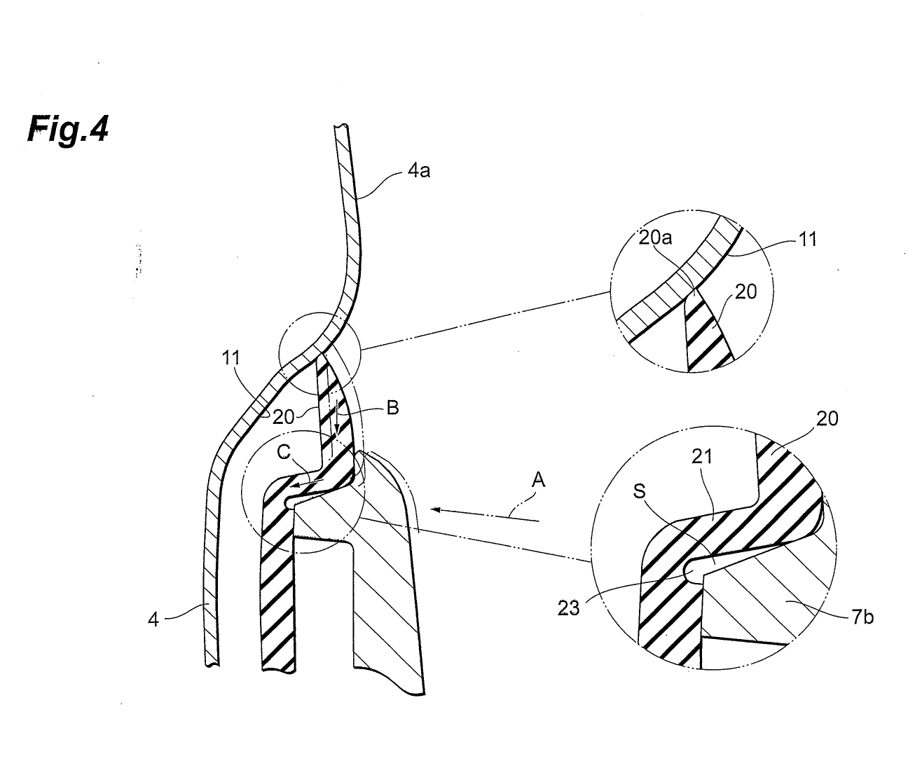

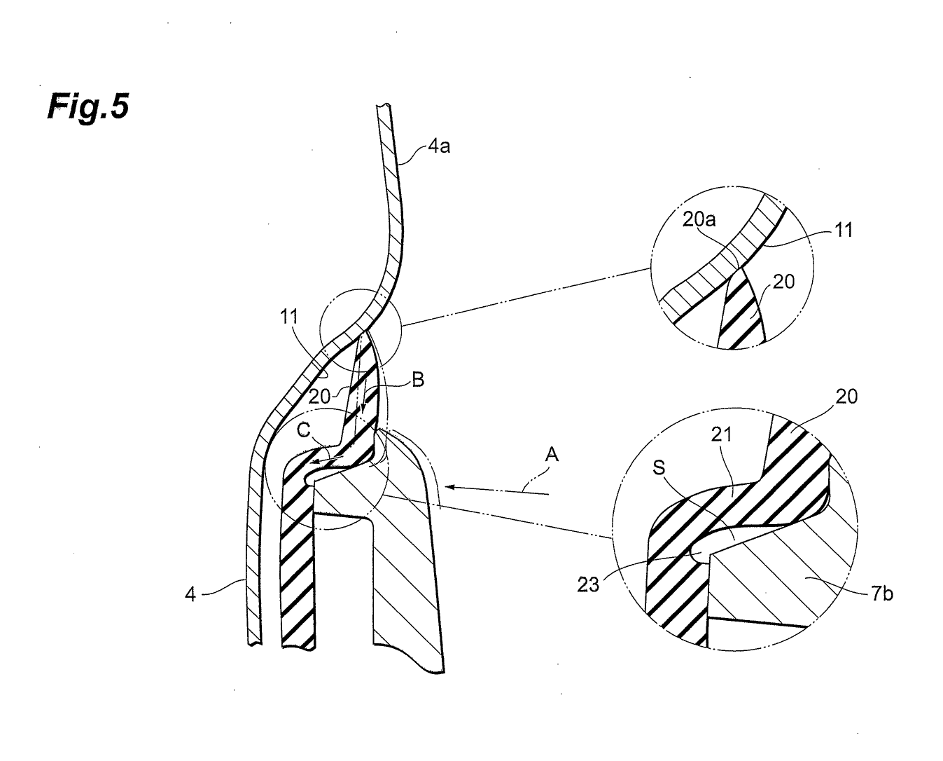

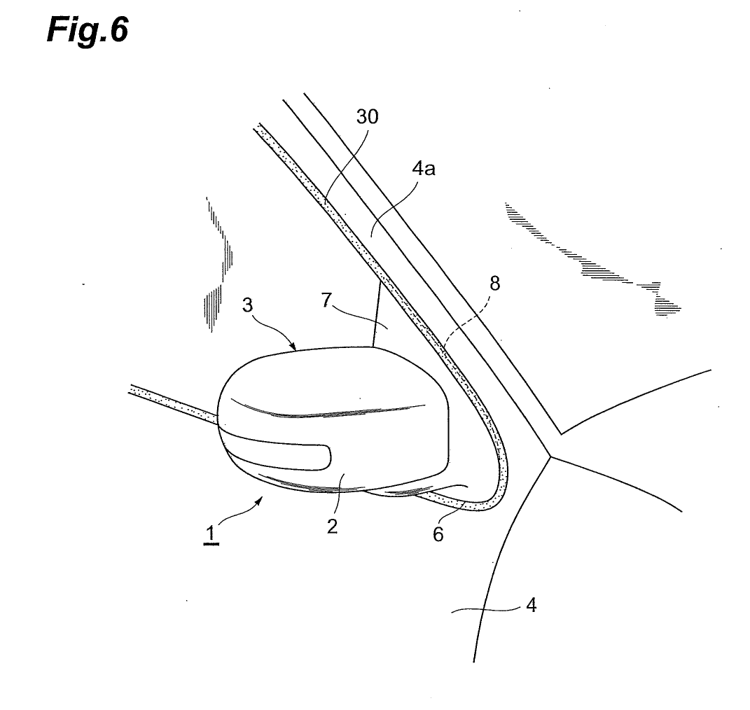

### BRIEF DESCRIPTION OF THE DRAWINGS

[FIG. 1] FIG. 1 is a perspective view illustrating a state in which a door mirror is attached to an automobile.

[FIG. 2] FIG. 2 is a perspective view illustrating a gasket and a door mirror base applied to the door mirror for an automobile according to the present invention.

[FIG. 3] FIG. 3 is an enlarged sectional view of an essential part of the gasket.

[FIG. 4] FIG. 4 is a sectional view illustrating a state in which the gasket is weakly brought into contact with a car body panel.

[FIG. 5] FIG. 5 is a sectional view illustrating a state in which the gasket is strongly brought into contact with the car body panel.

[FIG. 6] FIG. 6 is a perspective view illustrating another example of a state in which the door mirror is attached to the automobile.

### DESCRIPTION OF THE PREFERRED EMBODIMENTS

A preferred embodiment of a door mirror for an automobile according to the present invention will be described below in detail referring to the attached drawings.

As shown in FIG. 1, a door mirror 1 for an automobile includes a door mirror main body 3 constituted by containing a mirror in a housing 2, a door mirror base 7 fixed to a door mirror mounting portion 6 of a front door 4 in the car body panel, and a plane-shaped gasket 8 arranged between the door mirror base 7 and the front door 4 so as to ensure water tightness. This gasket 8 is molded from an elastic resin (polyethylene, for example) and has an outer shape extending substantially matching a peripheral edge of the door mirror base 7 made of resin and forming a substantial triangle and is used to fill a gap between the door mirror base 7 and the door mirror mounting portion 6.

As shown in FIG. 2, the door mirror mounting portion 6 is formed in a recess shape by a flat face 10 opposing a triangular gasket main body portion 9 and a peripheral wall face 11 standing with inclination to the surface of the front door 4 from the peripheral edge of this flat face 10 so that the gasket 8 is contained. On this flat face 10, a first recess portion 12 located in a lower part and a second recess portion 13 located in an upper part are formed, and to the first recess portion 12, a first projecting portion 14 formed on the gasket main body portion 9 is fitted so as to ensure the water tightness, while to the second recess portion 13, a second projecting portion 15 formed on the gasket main body portion 9 is fitted so as to ensure the water tightness.

Moreover, in the first recess portion 12, the second recess portion 13, the first projecting portion 14, and the second projecting portion 15, through holes 16 through which bolts (not shown) fixed on the back face of the door mirror base 7 penetrate are formed. This door mirror base 7 is fixed by the bolt having penetrated the gasket main body portion 9 and the door mirror mounting portion 6 on the back face side of the door mirror mounting portion 6 with a nut (not shown). Also, in the gasket 8, hole portions 18 to which positioning pins (not shown) formed on the back face of the door mirror base 7 are fitted are formed.

As shown in FIGS. 2 and 3, on an upper part of the gasket 8, a lip portion 20 to be brought into contact with the peripheral wall face 11 on the side of a pillar 4a (See FIG. 1) of the front door 4 is formed. This lip portion 20 has a tapered shape, and an outer side face 20b is bent from the distal end portion 20a to a base portion, while an inner side face 20c is formed linearly. Also, on the door mirror base 7, a lip contact portion 7a projecting in a direction substantially orthogonal to an attaching direction (See an arrow A) of the door mirror base 7 and forming a part of the peripheral edge is formed, and the base end side of the outer side face 20b of the lip portion 20 is brought into contact with this lip contact portion 7a. Then, the distal end portion 20a is brought into contact with the peripheral wall face 11 of the door mirror mounting portion 6 disposed on the front door 4 so that this lip portion 20 is compressed in the width direction as shown by an arrow B.

The lip portion 20 extends along the upper peripheral edge of the door mirror base 7 and is exposed with a predetermined width (4 to 10 mm, for example) from the peripheral edge of the door mirror base 7. The lip portion 20 and the gasket main body portion 9 are connected to each other by an elastic portion 21 thinner than the base end of the lip portion 20. This elastic portion 21 is formed between the gasket main body portion 9 and the lip portion 20, and has one end thereof being connected to the lip portion 20 through a first bend portion D1 creating a obtuse angle and the other end thereof being connected to the gasket main body portion 9 through a second bent portion D2 creating a obtuse angle. This elastic portion 21 extends diagonally across the lip portion 20 and the gasket main body portion 9 extending substantially in parallel, and the lip portion 20, the elastic portion 21, and the gasket main body portion 9 are connected so as to form a substantial S-shaped crank by the first bent portion D1 and the second bent portion D2.

On the door mirror base 7, a gasket main body contact portion 7b located on the inner side than the lip contact portion 7a and projecting in the attaching direction (See the arrow A) of the door mirror base 7 is formed, and the elastic portion 21 is separated from the gasket main body contact portion 7b with a gap S. This gap S extends over the entire length of the elastic portion 21 between the first bent portion D1 and the second bent portion D2. Moreover, on the inner face side in the second bent portion D2, a recess portion 23 with a C-shaped section extending along the direction where the distal end portion 20a of the lip portion 20 and the elastic portion 21 extend is formed.

The gasket 8 used in the door mirror 1 for an automobile as above has the lip portion 20 exposed with the predetermined width from the lip contact portion 7a forming a part of the peripheral edge of the door mirror base 7, and this lip portion 20 is brought into contact with the peripheral wall face 11 on the upper side of the door mirror mounting portion 6 disposed on the front door 4 from the arrow A direction. As shown in FIG. 4, the lip portion 20 is retreated in a direction to reduce the gap S while being compressed without being bent as shown by the arrow B. Then, a force is applied on the elastic portion 21 in a direction shown by an arrow C and the elastic portion is compressed. Such compression of the elastic portion 21 occurs when the lip portion 20 is weakly brought into contact with the peripheral wall face 11 of the door mirror mounting portion 6. This state is a contact state expected when designing.

However, in actuality, since variation in accuracy of the gasket 8 itself and the automobile component (the pillar 4a of the front door 4, for example) occurs, as shown in FIG. 5, if the lip portion 20 is strongly brought into contact with the peripheral wall face 11 on the upper side of the door mirror mounting portion 6 from the arrow A direction, the elastic portion 21 is largely deformed to deflect outward when the lip portion 20 is retreated so that the lip portion 20 can control the force applied to the peripheral wall face 11 of the door mirror mounting portion 6. Therefore, even if the distal end portion 20a of the lip portion 20 hits the peripheral wall face 11 of the door mirror mounting portion 6 disposed on the front door 4 more strongly than expected due to the variation in the accuracy of the gasket 8 itself or the automobile component (the pillar 4a of the front door 4, for example), the distal end portion 20a of the lip portion 20 can be reliably brought into close contact with the peripheral wall face 11 of the door mirror mounting portion 6. Then, a gap is hardly generated between the peripheral wall face 11 on the upper side of the door mirror mounting portion 6 and the lip portion 20, generation of a wind noise is prevented, water tightness is improved, and contribution can be made to improvement of the appearance quality of the joint when the door mirror 1 is attached to the front door 4.

Also, since the state shown in FIG. 4 is a design state, even if the distal end portion 20a of the lip portion 20 hits the pillar 4a of the front door 4 more weakly or even if the accuracy error of the gasket 8 itself or the automobile component (the pillar 4a of the front door 4, for example) becomes the maximum and the contact between the pillar 4a of the front door 4 and the distal end portion 20a of the lip portion 20 is close to point contact (See FIG. 3), the above-described effect can be exerted.

Also, the smaller the thickness of the elastic portion 21 is made, the more easily the elastic portion 21 deflects, but if the elastic portion is made thinner, when the distal end portion 20a of the lip portion 20 is brought into contact with the peripheral wall face 11 on the upper side of the door mirror mounting portion 6, the elastic portion 21 loses elasticity, and a gap can be easily generated between the distal end portion 20a of the lip portion 20 and the peripheral wall face 11 on the upper side of the door mirror mounting portion 6. Thus, by means of the recess portion 23 with a C-shaped section disposed on the inner face side in the second bent portion D2, whether the distal end portion 20a of the lip portion 20 weakly or strongly hits the peripheral wall face 11 on the upper side of the door mirror mounting portion 6 due to the variation in the component accuracy, the deflection of the elastic portion 21 can be easily controlled while the elasticity of the elastic portion 21 is maintained. And by making the section of the recess portion 23 in the C shape, the elastic portion 21 can be reliably deflected to bend outward.

It is needless to say that the present invention is not limited to the above-described embodiment. For example, the desired object can be achieved even if the lip portion 20 is disposed on the entire periphery of the gasket 8 or only on the upper side or the lower side.

As shown in FIG. 6, the distal end portion 20a of the lip portion 20 might be brought into contact with a molding 30 or the like forming a decoration member of plating fixed to the pillar 4a of the front door 4.

What is claimed is:

1. A door mirror for an automobile comprising:
a door mirror base fixed to a car body panel;
a gasket attached to the door mirror base; and
a door mirror main body mounted to the door mirror base,
wherein the gasket includes:
a gasket main body portion brought into contact with the door mirror base;
a lip portion extending along a peripheral edge of the door mirror base and exposed with a predetermined width from the peripheral edge of the door mirror base; and
an elastic portion formed between the gasket main body portion and the lip portion, and having one end connected to the lip portion through a first bent portion and the other end connected to the gasket main body portion through a second bent portion, and
wherein between the first bent portion and the second bent portion, a gap is formed between the elastic portion and the door mirror base; and
the lip portion has a distal end portion brought into contact with the car body panel or a molding fixed to the car body panel so as to be compressed in a width direction of the lip portion.

2. The door mirror for an automobile according to claim 1, wherein
on an inner face side in the second bent portion, a recess portion extending along an extending direction of the distal end portion of the lip portion is formed.

3. The door mirror for an automobile according to claim 2, wherein the recess portion has a C-shaped section.
